(19) United States
(12) Patent Application Publication
(10) Pub. No.: US 2023/0034751 A1
(43) Pub. Date: Feb. 2, 2023

(54) METHOD OF DEPOSITING A PORTION IN A PRECISE POSITION OR PARTS THEREOF AND DEPOSITING DEVICE SUITABLE THEREFOR

(71) Applicant: TVI ENTWICKLUNG UND PRODUKTION GMBH, Bruckmuehl (DE)

(72) Inventor: Thomas VOELKL, Bruckmuehl (DE)

(73) Assignee: TVI ENTWICKLUNG UND PRODUKTION GMBH, Bruckmuehl (DE)

(21) Appl. No.: 17/876,754

(22) Filed: Jul. 29, 2022

(30) Foreign Application Priority Data
Jul. 29, 2021 (DE) 102021119720.1

(51) Int. Cl. B65B 25/06; B65B 57/08; B65B 35/30

(52) U.S. Cl. CPC B65B 25/06; B65B 57/08; B65B 35/30

(57) ABSTRACT

Instead of a loading line consisting only consisting of conventional belt conveyors or strap conveyors, the invention uses—in addition to a conventional feed conveyor unit (10)—a large number of vehicles (F) which move independently of one another, freely on a driving surface (3″), and are driven from below the driving surface (3″), which each carry a packaging element (V) such as a tray, which—loaded with a single slice (S) or a portion—very flexibly permit the specific assembly of portions (P), but also the buffering of partial portions.

The buffer possibility can be supplemented by a (known) buffer (17) in the form of a vertical buffer with a vertically movable storage rack (17).

### CROSS-REFERENCE TO RELATED APPLICATIONS

This application claims priority to German Patent Application No. DE 102021119720.1 filed on Jul. 29, 2021, the disclosure of which is incorporated in its entirety by reference herein.

### TECHNICAL FIELD

The invention relates to the precise depositing of a portion consisting of one or more parts, in particular foodstuffs.

### BACKGROUND

Although such a part can also be a whole foodstuff, such as a piece of fruit, it is generally a part previously separated from a whole food piece, such as a slice of pineapple or a raw cutlet or steak cut from a piece of meat.

Such portions are usually sold shrink-wrapped in supermarkets and lie on a packaging element, either a flat, so-called cardboard, i.e., a plate made of plastic or clay material, or in a packaging trough, e.g., a thermoformed plastic packaging. Other types of packaging elements are also possible.

A sealing film extends over the foodstuff in the completely packaged product and is sealed tightly to the packaging element, i.e., either welded to the edge of the trough-shaped thermoformed packaging or tightly fastened to the cardboard, in particular to the underside of its edge.

For this purpose, it is necessary that the portion consisting of one, but usually several, parts is in a predetermined defined position on the packaging element before the sealing film is applied, in order not to make the application of the sealing film more difficult, in particular by the portion not extending into the area of the packaging element where the sealing film is to be fixed. Furthermore, by arranging the portion in a defined position and also the correct arrangement of the parts of a portion relative to one another, an attractive uniform visual appearance is desired.

Furthermore, portions also frequently consist of non-identical parts, whereby the parts are to be arranged in a specific sequence within the portion.

For the precise positioning of the portions and also the assembly of the portions, it has been common practice up to now for slices cut from a piece of meat—which will be referred to primarily in the following—or also parts cut off in some other way, such as the legs or wings of a chicken carcass, for the cut-off parts first to fall individually from the cutting device, in particular a slicing device, onto a feed conveyor unit to the packaging machine. There, they are grouped into portions or at least partial portions and dropped from this feed conveyor —which is often made up of several parts in the transport direction—onto the packaging element positioned in front of and below the ejecting feed conveyor. For this purpose, the packaging element must of course be positioned exactly in terms of position and rotation at this pick-up position, and this at considerable speed, since the cycle time for cutting slices from a product piece is often less than 0.5 seconds.

The packaging element is also usually transported and positioned by means of a conveyor belt, for which special forms of conveyor belts, which are constructed in a correspondingly complex manner, also enable a transverse offset of the packaging element and/or a rotation of the packaging element about the vertical axis.

However, it must be borne in mind that high hygiene requirements exist in the processing of foodstuffs and therefore, for all parts coming into contact with the foodstuff, on the one hand, there is only a narrow choice of material and, on the other hand, it must be possible to clean the device easily and thoroughly, which can be a considerable expense, particularly in the case of conveyor belts, even if these belt conveyors are designed in such a way that the conveyor belt can be removed relatively easily and cleaned separately.

### SUMMARY

It is therefore the object of the invention to provide a method for the positionally accurate depositing of a portion on a packaging element, as well as a suitable storage device for this purpose, in which the error rates in the positionally accurate depositing are lower than with conventional solutions, even with products that are difficult to handle, such as elastic slices of meat, and in which the device is easy to keep clean and to clean.

With regard to the method for the positionally accurate production of a portion from one or more parts in or on a packaging element, this task is solved by the sequence of the following steps:
First, the one part or already several parts of a portion are placed or dropped one behind the other on the feed conveyor, in the case of several parts one behind the other on the same feed conveyor and preferably forming a portion in which the individual parts at least overlap. The feed conveyor can consist of several parts in the transport direction, in which case the parts are placed or dropped on the rear-most feed conveyor in the transport direction.
Subsequently, the position and/or the rotational position of this deposited one or more parts on the feed conveyor is detected.
Subsequently, this at least one part lying on the feed conveyor is dropped onto the packaging element.

However, before this:
this packaging element is positioned in a defined position on a vehicle which does not have its own complete drive, i.e., would not be self-propelled on any driving surface —on which it is preferably independent of all other vehicles and freely movable in all directions.

Instead, this vehicle, which is referred to as “driveless”, is driven from below the driving surface—on which it is driving or above which it is hovering—whereby certain drive elements necessary for this purpose can be located inside the vehicle, such as permanent magnets, but indispensable parts of the drive are not located in the vehicle but below the driving surface in a driving floor or above the driving surface in a driving corner, for example an array of electromagnets.

In this way, the driveless vehicle can be moved by means of the e.g., the driving surface, and can also be positioned under the discharge end of the feed conveyor unit at a catch position defined with respect to the position and/or the rotational position for catching the portion or partial portion discharged by the discharging feed conveyor, as a rule in the case of several feed conveyors the last feed conveyor in the conveying direction, in such a way that the discharged portion or partial portion hits the packaging element in the desired position—with respect to position and/or rotational position.

During jettison, the vehicle will usually be stationary at a defined arresting position, which depends on the arresting parameters prevailing during jettison, i.e., all parameters that influence the jettison process on both the jettisoning side and the arresting side, such as:
discharge speed,
final edge of the ejecting conveyor,
parameters of the part to be ejected, such as adhesion to the ejecting conveyor, elasticity, weight,
height of the end edge in relation to the catching packaging element.

However, in order to prevent the slice from folding on the packaging element, it can also be useful for the packaging element, and thus the vehicle, to move in the direction of ejection, ideally at a speed corresponding to the horizontal component of the ejection movement at the time of impact on the packaging element.

In this way, the necessary positioning, also with regard to the rotational position, is handled by the vehicle alone, so that on the one hand only a small number of individual feed conveyors are required, and on the other hand the feed conveyors, in particular as belt conveyors or strap conveyors, can be of a very simple design, i.e., they do not have to be an expanding belt, nor do they have to be a belt enabling the rotation of the product lying on it, nor do they have to enable a transverse offset of the product lying on it.

This also considerably reduces the number of parts of the depositing device that are difficult and costly to clean, because the driving surface on or over which the vehicles move can be a smooth, dense, easy-to-clean surface, usually made of stainless steel, which is very easy to clean.

First of all, it should be clarified that there are in principle two different, also combinable, ways to produce a portion consisting of several parts—be their parts touching each other, even overlapping, or not—according to such portioning parameters on the packaging element.

In method A, the portion to be produced or also only a part portion thereof, which, however, can also already consist of several parts, is already formed on the feed conveyor unit, in that several parts are deposited there on this feed conveyor unit in the form of a portion or part portion, i.e., in the correct assignment to one another, in particular one after the other in time.

In method B, the portion to be produced or a partial portion thereof, which may also already consist of several parts, is first formed on the packaging element by dropping one or more parts, in particular also a partial portion, by means of the devaluating feeder onto the packaging element on the vehicle, in particular one behind the other in time.

As can be seen, a combination of the two methods is also possible, for example by forming a portion on the feed conveyor and depositing these two portions one after the other on the packaging element.

In this way, there is a high degree of design freedom as to how the portion to be formed on the packaging element is produced there.

Theoretically, the part or portion can also be placed directly on the vehicle instead of on a packaging element, but this greatly complicates further handling of the part or portion and is therefore not a priority.

Important in this procedure is the exact determination of the pick-up position at which the vehicle and thus the defined packaging element positioned on it must be located when the part or portion is picked up.

For this purpose, various catching parameters are preferably taken into account which also determine this catching position and which must be known or must first be determined, which can be:
the actual position and/or rotational position of the at least one part on the discharge feed conveyor
   and/or
the ejection speed at which the ejecting feed conveyor ejects or will eject this at least one part
   and/or
the weight of the part lying on the feed conveyor or of the portion or portion of the part
   and/or
the determined actual position not of the part to be ejected but of the preceding one or more parts on the ejecting feed conveyor and/or on the preceding packaging element
   and/or
the trend of the change of the actual position and/or rotational position of the one or more parts on the feed conveyor to be discharged and/or on the packaging element.

By means of these catching parameters, the control is able to calculate the catching position and to additionally optimize the calculation of this catching position by taking into account the positions of the preceding parts and, in particular, the trend of the change in position and/or rotational position from one drop to the next.

Often, when the part hits the packaging element, it will not be stationary, but will be in motion, including the supporting vehicle underneath.

Ideally, the horizontal speed of the vehicle should then correspond to the horizontal component of the ejection speed of the ejecting feeder, for which a fortiori some or all of the aforementioned catching parameters should be taken into account in order to correctly determine the speed and/or direction and/or rotational position of the packaging element at the moment of ejection at the catching position.

When producing portions, at least one portioning parameter must generally be observed, for example a target weight of the portion.

However, there are also portioning parameters that are more difficult to comply with, which is why, when creating portions, in particular from slices of meat, on such a packaging element, the slices should not be deposited on the packaging element as a portion in the order in which they are separated from the piece of meat, or, generally speaking, delivered parts of a foodstuff cannot or should not be deposited on the packaging element in the order in which they are delivered.

This can have different reasons.

When producing weight-accurate portions, it may be that the last slice to actually be added to the portion in order of separation would then result in a portion that is outside the permissible weight limits, and instead another slice with a higher or lower weight is to be added as the last of the portion.

Another reason can be, for example, optical reasons, in that one would like to have slices cut from a piece of meat that is irregular in the slicing direction also follow one another with regard to their position and thus possibly size in the piece of meat and/or their color and/or other sorting parameters—which characterize the individual slice.

For example, a portioning parameter may be that a portion should consist in the correct ratio and sequence of consecutive slices from different areas of the piece of meat from which they are cut, for example one slice from the starting area, 3 slices from the middle area and one slice from the end area of these pieces of meat.

Also such a portion cannot be obtained directly after the slicing machine. In this case, only a partial portion, for example the initial slice, is initially placed on the packaging element, which is then temporarily stored and, if further suitable slices are available, these are added.

Further sorting parameters for a single slice can be:
the weight of the part, especially the slice
   and/or
the size of the part not only in its main plane, but also or instead transversely to it, in particular in its height
   and/or
the curvature of the food.

Such a portioning requires that parts currently transported towards the packaging element, but which do not meet the currently required sorting parameter, are not deposited on the packaging element, but are temporarily stored for use on another packaging element and/or until a part meeting the currently required sorting parameter is available.

According to method B above, such portioning can be performed only by means of the vehicle.

Thus, only a first part of the portion to be produced, be it a single part or a first part-portion, can be deposited on the packaging element of the vehicle, for example consisting of slices separated one after the other, because these have all fulfilled the sorting parameters to be fulfilled so far.

If the next part transported in the direction of the packaging element does not have the sorting parameter(s) currently to be fulfilled, the vehicle is moved away from the receiving position and parked offside, and only when a next suitable part is available on the ejecting feed conveyor, which therefore fulfills the current sorting parameters for this packaging element/portion, the vehicle is moved back to the receiving position and this suitable part is deposited on the packaging element.

The process of parking the vehicle away from the packaging element and only returning to the pick-up position when the next suitable part is available can also be repeated several times in succession until the desired portion has been completed.

Since a large number of such independently movable vehicles are generally available, portioning and delivery of the finished portion to a packaging machine is accelerated simply by the fact that, during the period in which a particular vehicle picks up a new part or a new portion, other vehicles simultaneously travel their routes for transfer to the packaging machine, to a parking position or from a parking position to the next pickup position to be approached, or their format plates are exchanged or cleaned.

The suitability, whether the part is suitable for the corresponding position within the portion to be produced or not, is thus determined on the basis of the sorting parameters, preferably of course automatically determined by means of the control and the corresponding sensor system connected to it for determining these sorting parameters.

For example, one of the feed conveyors of the feed unit can be equipped with a scale for determining the weight of the part or portion lying on it, a camera can be present above the feed conveyor for determining the size and/or position and/or rotational position, a speed sensor can be present on the drive shaft of the feed conveyor, in particular of the ejecting feed conveyor, for determining the ejection speed.

The portioning possibilities can also be created by other measures or further increased compared to portioning only with the aid of the vehicles in order to make portioning even more flexible.

For example, parts or portions that are currently not suitable can be stored separately from one another in intermediate storage.

Since each individual storage location in such an intermediate storage system fulfills the same storage function as a vehicle parked off to the side, the number of vehicles required and also the need for driving space and parking space for this can be kept low and/or the complexity of the portioning processes can be increased.

In order to keep the complexity of the drive and/or control system driving the vehicles below the driving surface within limits, the possible movements of the vehicles can be selected to be more or less varied.

If the vehicle does not also have to be able to rotate about its vertical axis when its direction of travel is changed, but instead continues to travel at an angle to this new direction with the same rotational position after the change in direction, this is a simpler solution to implement than to also effect a rotation of the vehicle about the vertical axis in an analogous and adapted manner when the direction is changed, so that the vehicle thus performs a typical cornering maneuver and always points with its front side in the current direction of travel.

It also simplifies the solution if a rotation of the vehicle about the vertical axis is only possible, for example, when the vehicle is stationary.

With regard to a storage device, this task is solved in that it comprises, on the one hand, a feed conveyor unit which takes over individual parts or portions or a whole portion from an original source of the parts, in particular a slicing machine, and feeds it to a packaging element and can drop it thereon.

On the other hand, the storage device comprises a vehicle system with a plurality of vehicles without drive alone, on which the packaging element is located. This vehicle system is designed in such a way that the vehicles travel on a travel surface or hover above a travel surface and can be driven independently of one another by a drive arranged below the travel surface, preferably contactlessly, for example magnetically, and can thus be positioned precisely in terms of position and/or rotational position at a collection position below the dropping feeder.

Parts of the drive, for example permanent magnets, may well be located in the vehicle, but not the entire drive, so that the vehicle cannot be driven without drive parts located outside the vehicle.

Furthermore, a control is provided for controlling at least moving parts of the unloading device.

The vehicles are the vehicles of a vehicle system which, as described above, are not capable of driving on a movable driving surface on their own, but only with the aid of the specific drive present under the driving surface in the driving plate, whereby parts belonging to this drive, such as magnets, may well be arranged in the vehicle.

The existing control system controls both the vehicle system and the feed conveyor unit for this purpose, whereby the vehicles can be moved independently of one another on the driving surface or hover above the driving surface at a distance and can thus also be positioned exactly in terms of position and rotational position at a collection position specified by the control system below the ejecting feed conveyor.

Despite only a few, ideally only one, infeed conveyor, this creates a highly flexible storage device.

As different packaging elements—depending on the order, if necessary—can even be Since different packaging elements have to be used—depending on the order, if necessary even mixed during the cutting of one and the same batch of food pieces—each vehicle preferably has a mounting device, with the aid of which a format plate can be fastened in a defined position, in particular positively, in a very simple manner on the upper side of the vehicle, which format plate is matched in terms of position and design on its upper side, for example by means of positively locking mounts and stops, to the packaging element to be arranged on it, which can thus be arranged in a defined position on the format plate and thus on the vehicle.

Preferably, the fastening device is designed in such a way that one and the same format plate can also be positioned on the vehicle in several different positions, for example rotated by 90° relative to one another or offset in one of the horizontal extension directions of the vehicle. This further increases the variability of the storage device.

Preferably, the driving surface consists of a closed and preferably flat and/or dense upper surface of a driving plate, which is made of a material that is easy to clean, in particular stainless steel.

In this way, completely different portions can be produced from one batch of food pieces to be cut open, for example portions only from the initial part of the food piece or portions only from the middle part of the food piece or also portions mixed with parts from different areas of the food piece.

### BRIEF DESCRIPTION OF THE DRAWINGS

Embodiments according to the invention are described in more detail below by way of example. They show:

FIGS. 1a-e: a first design of the storage device in side view,

FIGS. 2a-f: a top view of the storage device of FIGS. 1a-e,

FIGS. 3a-c: a second design of the storage device in side view, and

FIG. 4a, b: the storage device of FIGS. 3a, b in top view, each in different functional states.

### DETAILED DESCRIPTION

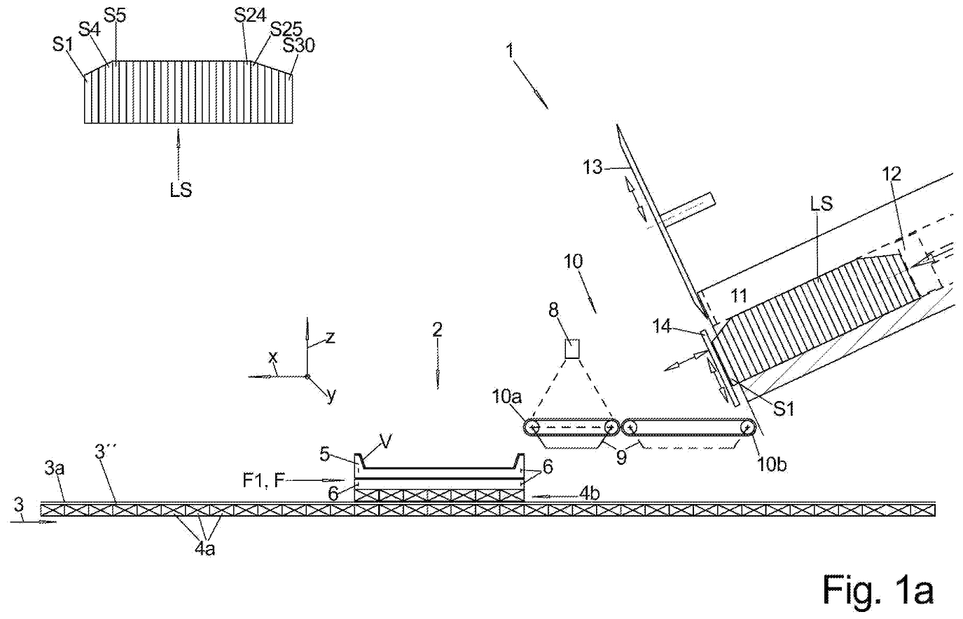

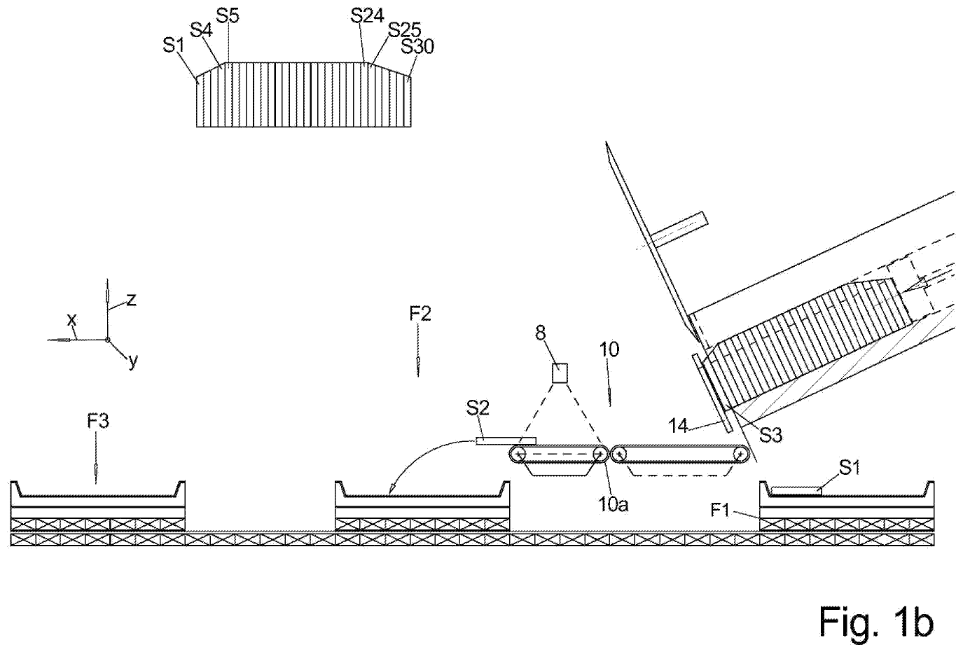

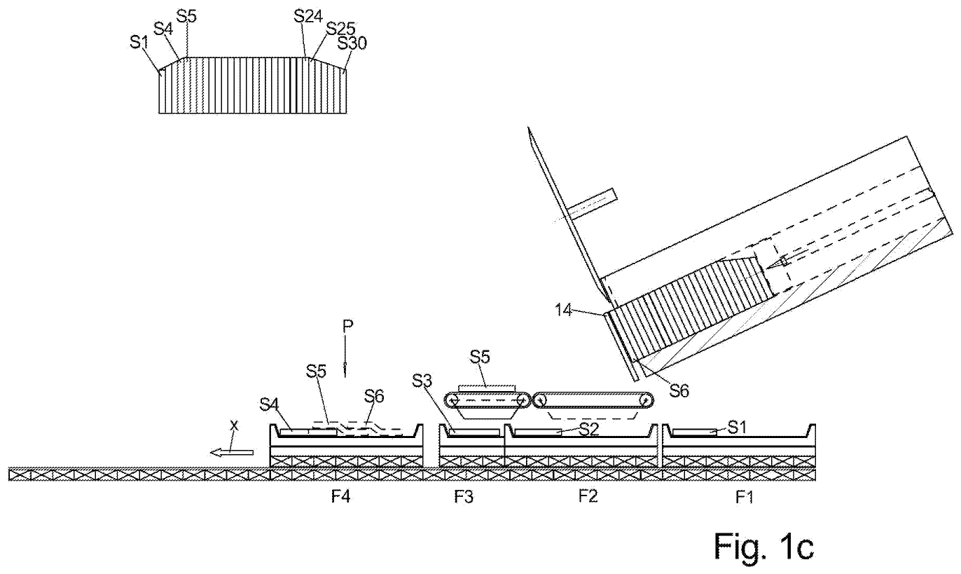

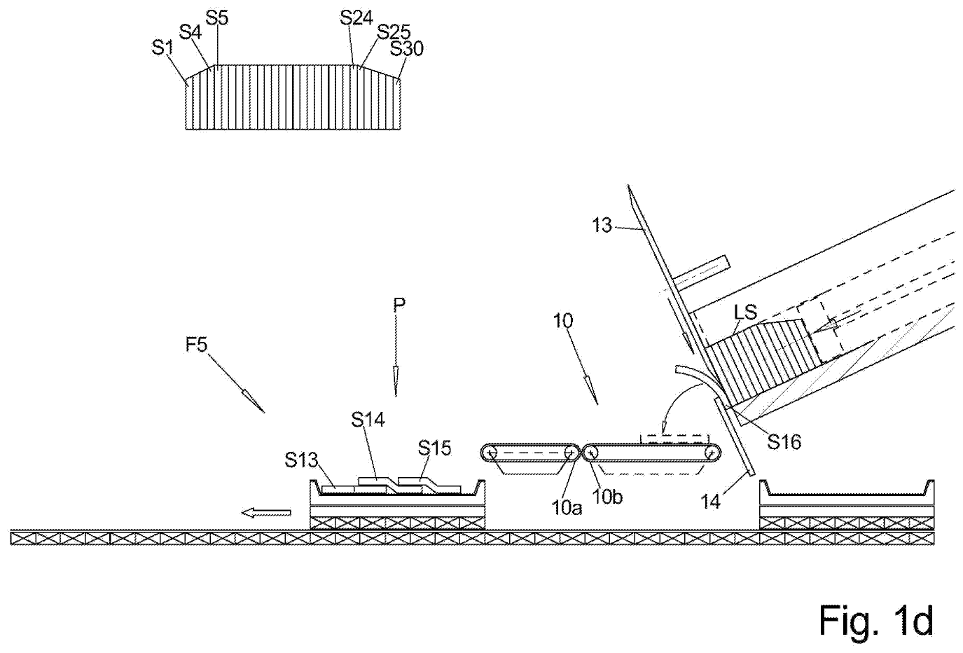

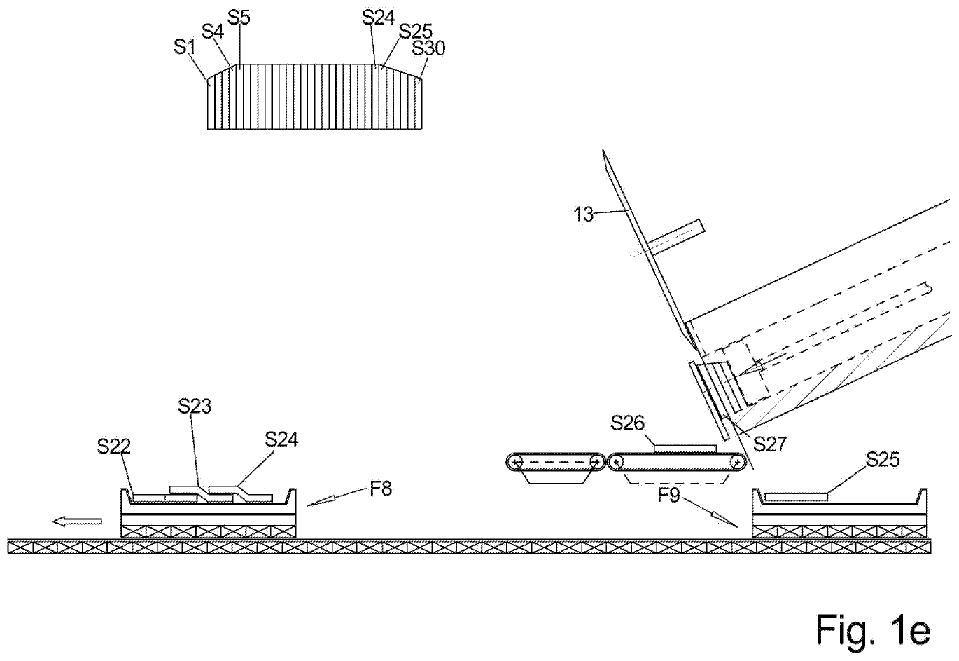

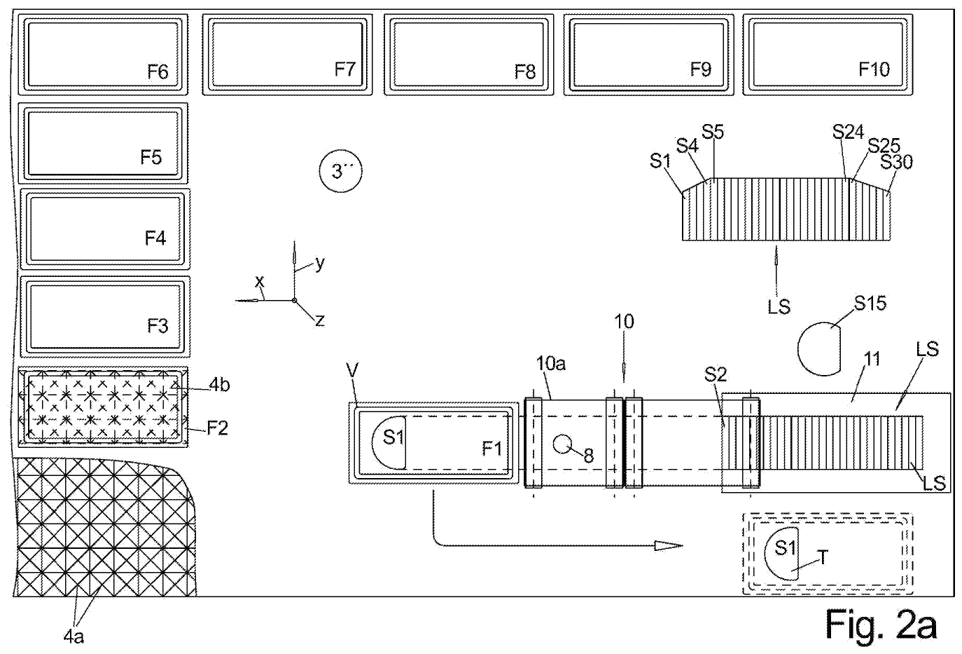

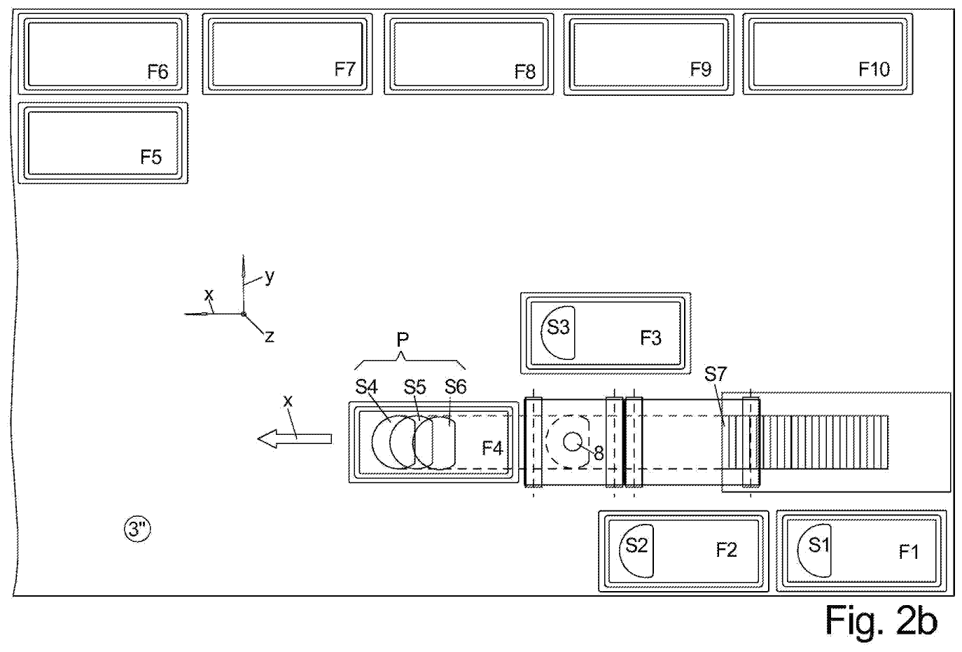

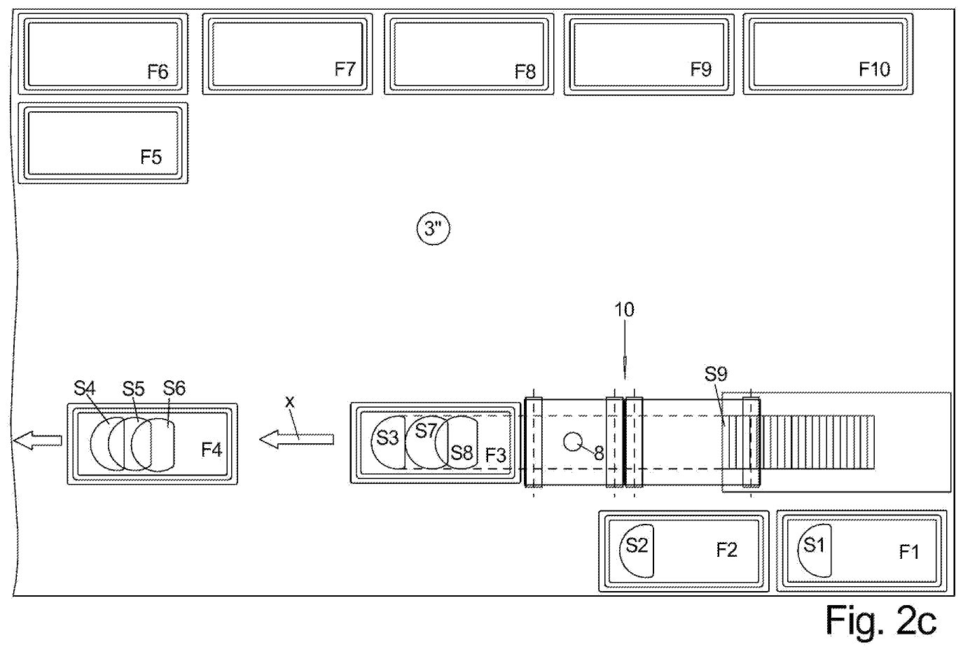

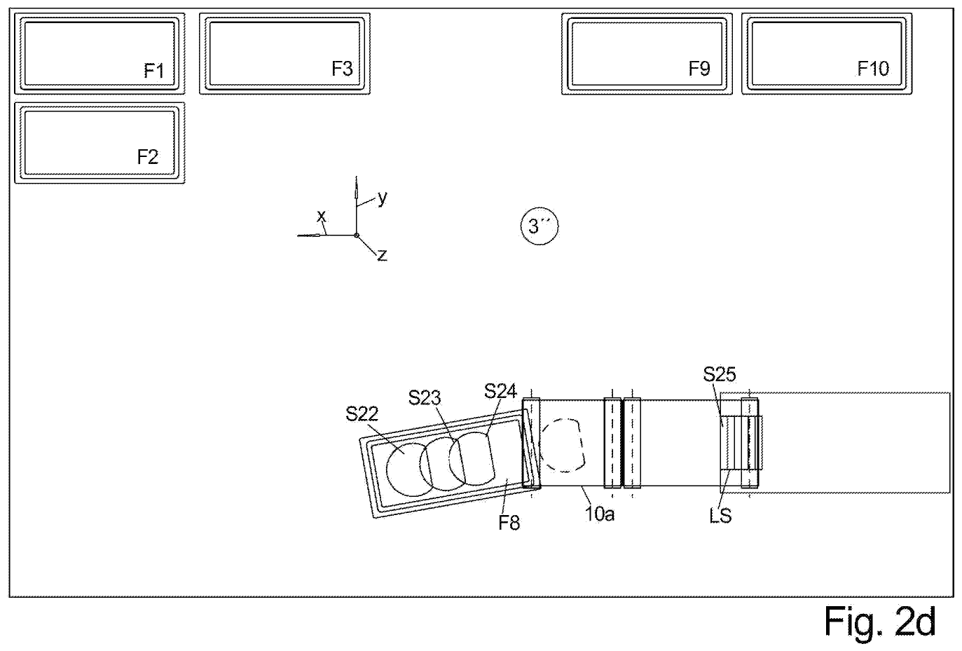

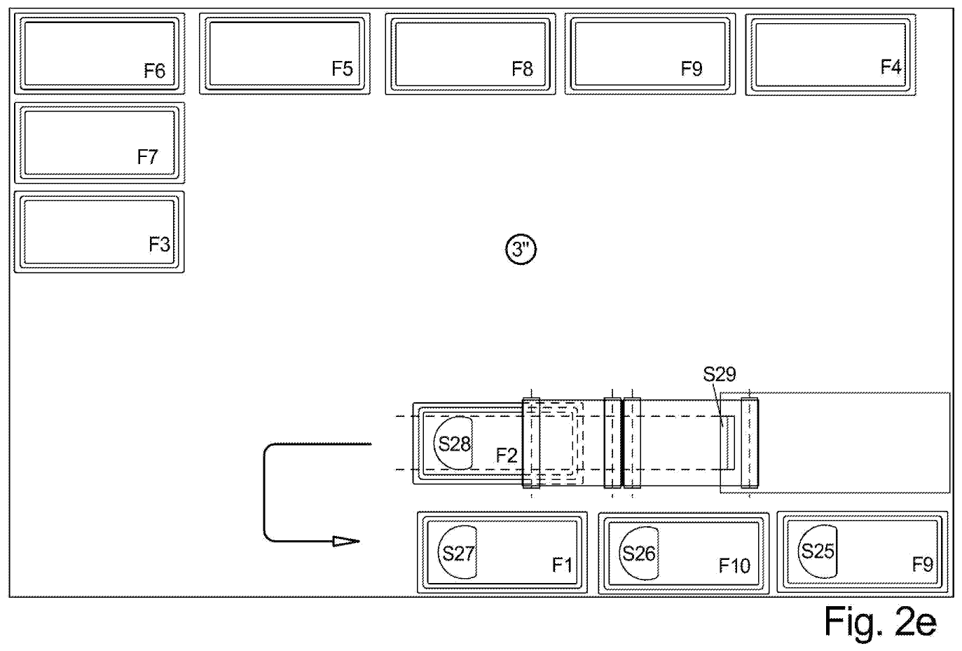

As best shown in FIG. 1a and FIG. 2a, the storage device 1 consists of a vehicle system 2 and a feed conveyor unit 10 for loading the vehicles F, in that the feed conveyor unit 10 transporting in the conveying direction X can consist of several conveyors 10a, b in the conveying direction X, as shown, for example two, the foremost of which in the conveying direction X is a dropping conveyor 10a, which in such a height position and X-position relative to a vehicle F of the vehicle system 2 standing in a catching position or also travelling in the conveying direction X ends with its discharge end, so that parts T, in particular slice S, falling over the end of the driven discharge conveyor 10a come to lie on the vehicle F, in the case of flat parts T such as slice S preferably lying flat and not folded. One of the conveyors 10a, b is generally equipped with a scale 9 for weighing the part T lying thereon.

The vehicle system 2 comprises a plurality of vehicles F, in this case F1-F10, which are capable of being moved independently of each other in a controlled manner on the moving surface 3″, which is spanned by the X and Y directions and on which the vertical Z is preferably perpendicular.

However, the vehicles F do not have their own drive motor with which they can travel on any travel surface by means of wheels, for example, but are quasi-driveless, since the main part of their drive is located under the travel surface 3″ in the travel floor.

This consists, for example, as seen in plan view, of an electro-magnet as bottom magnet 4a—only indicated in FIG. 2a—arranged in a grid-like manner, preferably in the form of a rectangular grid oriented in the X and Y directions and preferably with only the smallest distance from one another, whose magnetic field generated in the activated state penetrates the driving surface 3a running above it, in that this consists of a magnetically permeable material such as a plate of stainless steel.

The vehicles F also have magnets on their underside, but preferably permanent magnets as vehicle magnets 4b, likewise distributed in a grid-like manner over the bottom surface of the vehicle F, preferably with the same grid orientation and preferably the same distances of the vehicle magnets 4b as those of the bottom magnets 4a. The vehicle F is thus moved in a desired direction by selectively actuating certain bottom magnets 4a in a time-delayed manner.

On the upper side of the vehicle F there are one or more fastening devices 6 which permit the fastening, preferably by form-fit attachment, of a format plate 5, the upper side of which allows form-fit attachment to the shape and dimension of the packaging element V to be placed thereon, in this case a tray V in the form of a trough.

The format plate 5 can also project laterally, even in all directions, over the vehicle F as seen in plan view, and in particular the fastening devices 6 are arranged in such a way that the format plate 5, as seen in plan view, can be placed and fastened on the vehicle F in a plurality of rotational positions which differ from one another, for example by 90°.

Where the feed conveyor unit 10 obtains the parts T to be transported by means of the vehicles F and also to be stored between them, and which parts of foodstuffs—be they whole food pieces or parts of food pieces—are involved, is irrelevant to the present invention.

Shown as parts T are the slices S of a food piece LS to be sliced, such as a piece of meat, which in this case is pushed forward obliquely downward in a forming tube 11, and the protrusion of which over the forming tube 11 is cut off by a blade 13 which is movable back and forth transversely to its direction of extension, in this case rotating, whereby the cut-off slice falls flat onto the beginning of the feed conveyor unit 10 due to the oblique position.

In order to determine the thickness of the slices S, the food piece LS, in this case the piece of meat, is pushed forward in the forming tube 11 by means of a longitudinal press stamp 12 until it reaches a stop plate 14, which together with the blade 13 can move back and forth transversely to the direction in which the forming tube 11 extends.

This food piece LS in the form of a piece of meat is shown again separately in side view at the top left of FIG. 1a in order to illustrate the problem of slices S1 to S30 of different size and thus different weight with the same thickness.

As a rule, such a piece of meat is not cuboidal, but has an increasing and decreasing cross section at the beginning and end, respectively, as schematically indicated.

Depending on whether the forward pushing by means of the longitudinal press stamp 12 results in a compression of the slice of meat LS or only in a forward pushing, the slice of meat LS also assumes in its initial and final sections the cross section of the forming tube in which it is accommodated, or only partially or not at all, so that with unchanged slice thickness the slices become of different weights.

Likewise, the initial part and the final part of the piece of meat may differ from the central uniform part also in other parameters, for example, its color, fat content, and the like.

Frequently, however, portions P are to be produced on the packaging element V from several, here in each case three, mutually partially overlapping, i.e., shingled slices as shown in FIG. 2c. In this case, however, at least the completely visible uppermost slice should always originate from the middle part of the piece of meat, and preferably also the next lower, here middle, of the three slices.

The slices S1 to S4 from the initial portion or S25 to S30 from the final portion, which have a different appearance and/or possibly a different weight or size, should not form the uppermost but rather the lowermost slice of the portion P on the packaging element V and must therefore be dropped first onto a vehicle F with the packaging element V, but then it is necessary to wait until slices from the middle portion S5 to S24 are cut open and are available.

The problem arises that the slice S can experience a deflecting force due to the direction of rotation of the blade 13, which leads to the separated slice S on the feed conveyor 10, in particular after transfer from one conveyor to the next in the case of a multi-part feed unit, on the ejecting conveyor 10a is not always in the exact nominal position and nominal rotational position (viewed from above), which is, however, the prerequisite for this slice being in the exact nominal position there after ejection on the packaging element V. This, in turn, is necessary so that the edge of the slice S is in the exact nominal position.

This in turn is necessary so that the edge of the packaging element V, in this case the tray, is not covered or soiled by the slice S, since it is to be tightly sealed after complete filling with sealing film, which is to be tightly sealed onto this edge. In order to save packaging material, the packaging element V is also dimensioned relatively close to the portion P to be deposited.

With the vehicles F which can be moved on the moving surface 3″—if necessary also floating, however preferably sliding on sliding feet—both the buffer problem existing with a desired sorting within the portion P and the positioning problem can be solved exclusively with the aid of the vehicle system 2 and without further aids as shown on the basis of the FIGS. 1 and 2, whereby, however, the FIGS. 1 and 2 corresponding to each other from the designation do not represent the analogous function state.

FIG. 1a, for example, shows the initial state in which the food piece LS has already been placed against the stop plate 14, but the first slice S1 has not yet been separated.

In FIG. 2a, however, this has already been done and the first slice S1 has already been dropped on the tray as packaging element V of the vehicle F1 by means of the feed conveyor unit 10, for which purpose the vehicle F1 was placed in the correct pick-up position, e.g., partially retracted under the drop end of the dropping feed conveyor 10a, by the control. It can be seen that this first separated slice S1 is smaller than the slice S15 from the middle area, here S15, shown separately in FIG. 2a for size comparison.

Furthermore, in FIG. 2a the food piece LS is again shown in side view for orientation purposes, since in the top view of FIG. 2 a constant width is assumed over the entire length.

Since slices from the central area with a uniformly large cross section of the food piece LS, i.e., from slice S5 to S24, are desired on the vehicle F1 as further slices of the triple portion, the vehicle F1 loaded only with slice S1 is then moved to a parking position as indicated, and one of the further vehicles F2 to F10 shown in the parking position with still empty packaging element V is used, for example the vehicle F2, as already shown according to FIG. 1b standing ready at the impact point, onto which the next pane S2 is just dropped by the dropping conveyor 10a.

The now foremost slice S3 of the piece of meat is already in contact with the stop 14 and is ready to be cut off by the blade 13 in order to then be deposited by the infeed conveyor unit 10 on the vehicle F3 and its packaging element V and to then also move the vehicle F2 into a parking position as shown in FIGS. 1c and 2b.

However, the following slice S4 is the last slice of the front end area of the piece of meat. This is deposited on the vehicle F4, for example, but since slices S5 and S6 now follow from the uniform middle section, these can be separated immediately afterwards and also deposited on the vehicle F4, as can be seen in FIGS. 1c and 2b, and then the vehicle F4, which is now carrying a complete portion P, can be moved away—in this case out of the visible range of the figures—for further processing of the tray V with the finished portion P in it.

Then, according to FIG. 2c, one of the parked vehicles loaded with only one slice from the initial area, in this case F3 with slice S3, is moved to the impact point under the discharge end of the discharge conveyor 10a and thereupon loaded one after the other—of course with movement of vehicle F3 in conveying direction X in between, i.e., to the correct collection point—with the next slices S7 and S8 from the middle area and can then drive away with complete portion P for further processing.

In the same way, the portions are then completed on the vehicles F2 and F1, for which the slices S9, S10 and S11, S12 are used.

After this, there may be no more part portions to be completed on vehicles, so that now the remainder of the central part with slices separated in each case in sequence can also be created in portions deposited in sequence in a vehicle, as shown in FIG. 1d for vehicle F5 and the slices S13 to S15 therein.

FIG. 1d also shows how the next slice S16 is already separated from the food piece LS and falls onto the rearmost conveyor 10b of the feed conveyor unit 10.

The last vehicle which can be completely loaded with slices from the center section is the vehicle F8 carrying the slices S22 to S24, as shown in FIG. 2d.

Here it can be seen that the last slice S24—merely as an example—was lying twisted on the discharging conveyor 10a, which is why the vehicle F8 for collecting the slice S24 is also positioned at an analogous angle and, if necessary, not at the same transverse position in the conveying direction as the discharging conveyor 10a at the collection point, in order to produce a portion P consisting of shingled slices S22 to 24 which are exactly aligned with one another.

The position and rotational orientation on the dropping conveyor 10a has previously been determined by the position detector 8, preferably a camera 8 suspended above this dropping conveyor 10a, and reported to the control.

The next slice S25 subsequently waiting to be separated from the piece of meat LS is the first slice of the rear end region and is already somewhat smaller than the slices S5 to S24 of the middle region and, according to FIG. 1e, has already been deposited on a vehicle F9 and the packaging element V there, and the vehicle F9 has been moved to the parking position loaded only with this one slice S25 as a part portion, and to perform the same subsequently also for the slices S26, S27, S28 as shown in FIG. 2e and furthermore also for the slices S29 and S30 as shown in FIG. 2f.

Since in this case the rear end section is longer than the front end section and comprises a total of six slices, six of the total of ten available vehicles are used in this condition for intermediate buffering of one slice each of the rear end section.

Subsequently, the procedure is the same as described for the beginning of the piece of meat LS, but with the following difference:

While in the first slice of meat LS after slice S12 no more vehicles with unfinished portions were in waiting position, now from the end of the first slice of meat LS, e.g., six vehicles are in waiting position, each loaded with a smaller slice from the rear end area. Each of them, starting from slice S13 of the middle area, is again driven under the dropping conveyor 10a and two slices, e.g., S13 and S14, are deposited thereon one after the other in order to complete a portion there on three slices, for which all slices up to slice S24 of the middle area are required until the last of the six buffering vehicles.

Then the slices of the rear end section of the next piece of meat LS are again buffered individually on one vehicle each and this is moved to a parking position.

Depending on how long the initial and final sections of such a piece of meat are, a relatively large number of vehicles F of the vehicle system 2 may be required merely for the intermediate buffering of, for example, one slice each from the final section.

Since the vehicles F are expensive to purchase and, in particular, the required parking space is expensive since it must also be occupied by bottom magnets 4a, it may be worthwhile to provide another buffer instead of and/or in addition to the vehicles F of the vehicle system 2.

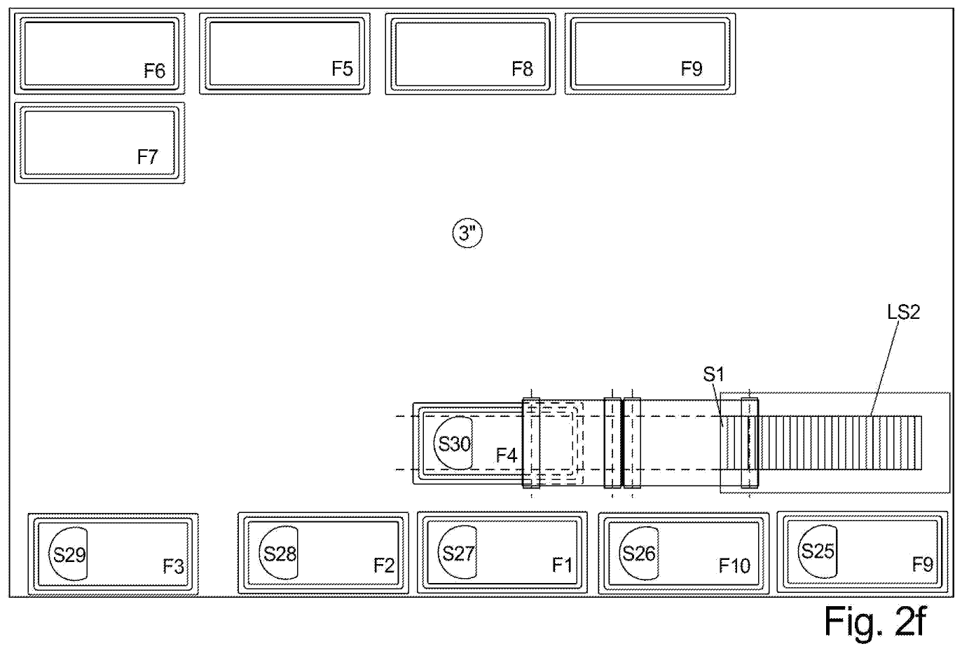

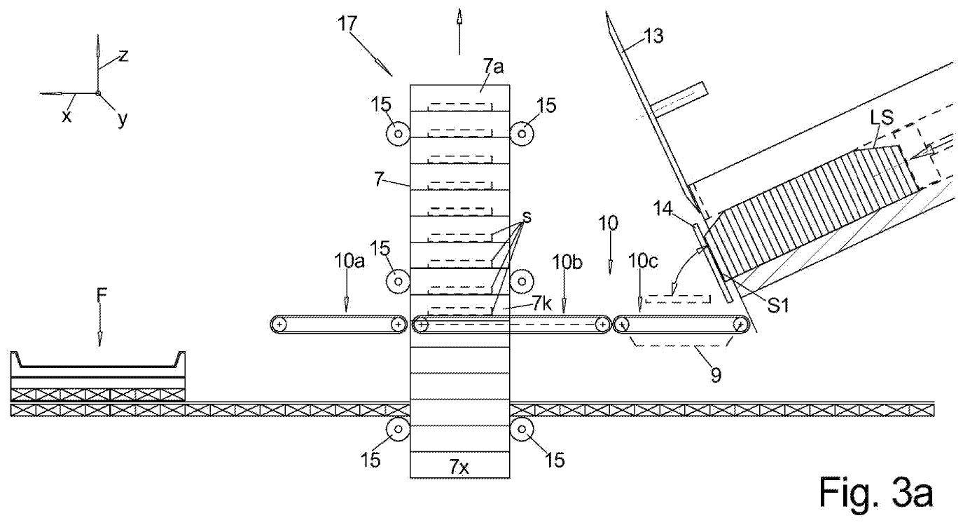

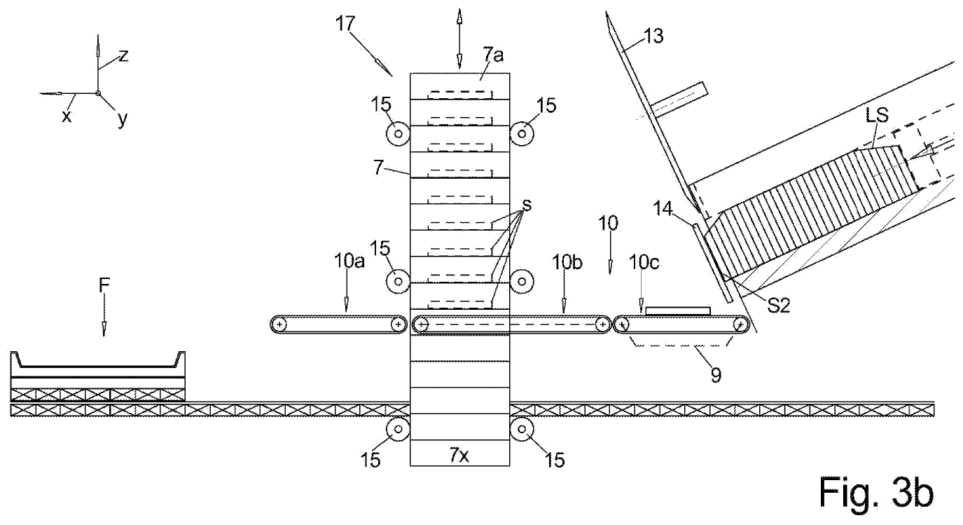

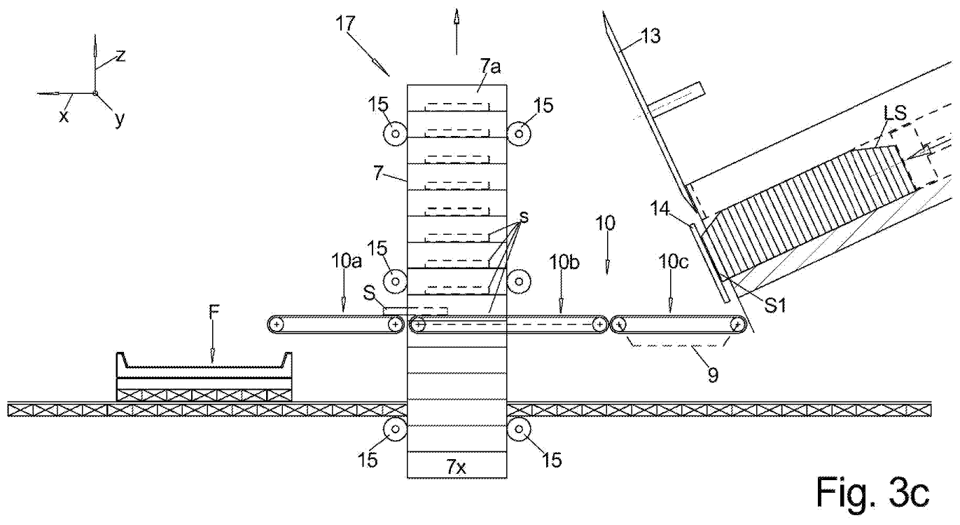

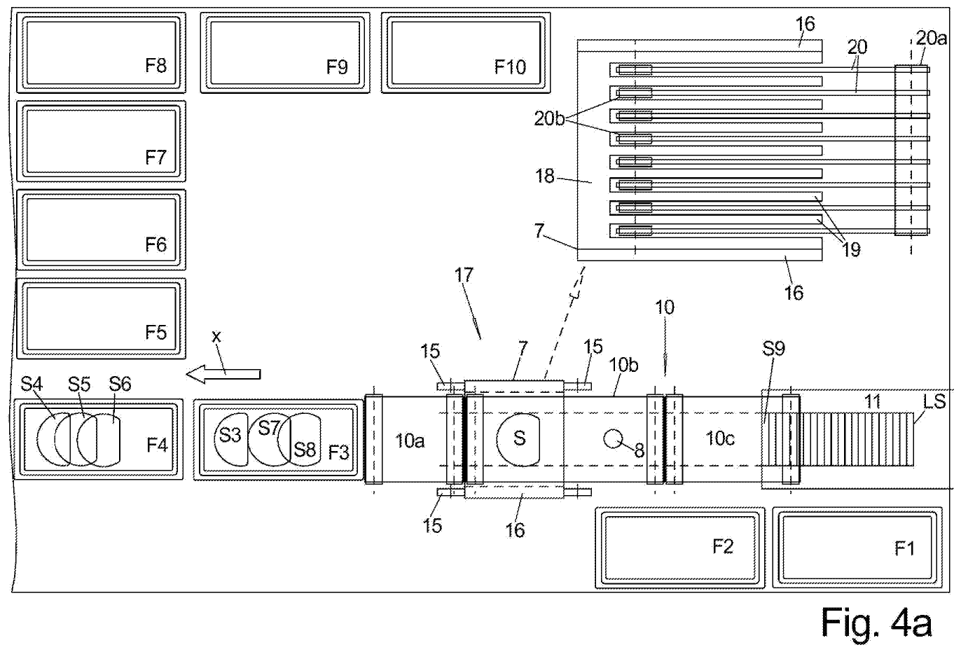

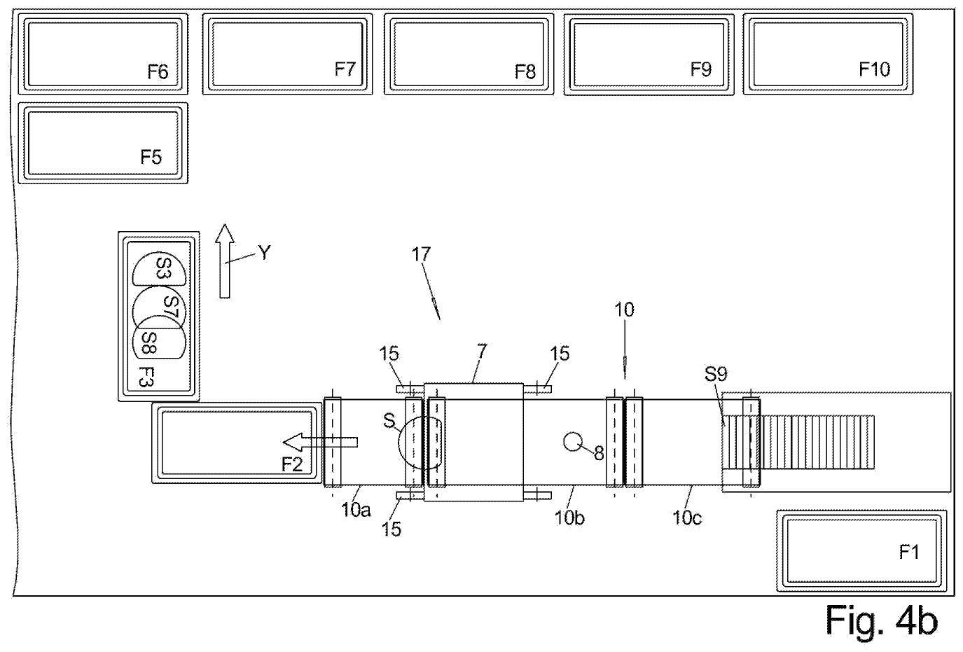

Thus, FIGS. 3a, b, c in side view and FIGS. 4a, b in plan view show a design of the storage device 1 in which there is an additional vertical intermediate storage 17 consisting of a plurality of compartments 7a to 7x arranged one above the other, open in and against the direction of conveyance X, which are fixedly connected to one another to form a storage rack 7 which is connected to each desired storage compartment, e.g., 7k, by means of controllably drivable transport elements, in this case drive rollers 15 which engage laterally with the upright side cheeks 16 of the storage rack 7 lying in the conveying direction X and are rotatable about a horizontal axis. 7k, for example, to such a height that the conveyor 10b loading and unloading the intermediate storage 17 directly upstream in the conveying direction X for this purpose can deposit a part, for example a slice S, therein.

For this purpose, as seen in plan view, this upstream conveyor 10b extends from its upstream end in conveying direction X into the intermediate storage 17 up to its downstream end, whereby the slice S is located in the longitudinal area of the intermediate storage 7 in the X-direction, as shown in FIG. 4a.

This is possible in that—as shown in the enlargement in FIG. 4a—the shelves 18 of the storage compartments 7a to 7x consist of spaced support bars 19 which are connected to each other only at their downstream ends and can therefore move vertically between individual, endless straps 20 which circulate in vertical planes lying in the direction of conveyance X. The straps 20 are driven in synchronism with each other.

The cooperating conveyor 10b, which is designed as a belt conveyor, consists of these synchronously driven straps 20.

The straps 20 rotate at their upstream end outside the bearing shelf 7 over a common driven deflection drum 20a extending over the entire width of the conveyor 10b. At its downstream front end projecting into the bearing rack 7, each strap 20 rotates over its own separate deflecting roller 20b, which are not connected to each other in the transverse direction Y, but are each connected to each other by a not shown deflecting roller 20b running in the conveying direction X. The deflecting rollers 20b and 20b are driven by the conveyor 10b, upstream of the storage rack 7, the free distance in the transverse direction Y between the individual deflection pulleys 20b, as seen in plan view, being large enough for one support bar 19 each to be able to move through them in the vertical Z.

By raising the storage rack 7 in such a way that a shelf 18, which previously was with the upper side of its support bars 19 still below the upper side of the upper spaces of the straps 20 of the conveyor 10b—as shown in FIG. 3a—passes these upwards, as indicated by the vertical arrow in FIG. 3a, and takes the slice S lying on it upwards according to FIG. 3b, the conveyor 10b is free to transport the next slice into the intermediate storage 7.

In this way, the storage rack 7 can be filled with, e.g., a slice S, starting with the uppermost compartment 7a and from there continuously downwards, until they are required again.

For removal, a shelf 18 on which a slice S lies is moved analogously in reverse to just below the upper side of the tops of the straps 20 of the conveyor 10b, so that the slice S is then driven in the direction of rotation on the conveyor 10b whose straps 20 are then driven in the direction of rotation, whereby the slice S is transferred to the following downstream conveyor 10a in alignment, as can be seen in FIG. 3c and FIG. 4b, and can be dropped onto a vehicle F standing by at the collection position.

In this way, the intermediate storage 17 can be emptied compartment by compartment, but as can be seen only in the order of the filled compartments from bottom to top, so that such an intermediate storage 17 can only be operated according to the last-in-first-out principle.

### REFERENCE LIST

1 storage device
2 vehicle system
3 driving plate
3a driving plate flooring
3″ driving surface
4 drive
4a bottom magnet
4b vehicle magnet
5 format plate
6 mounting device
7 compartment
8 position sensor, camera
9 scale
10 feed conveyor unit
10a discharging feed conveyor
11 forming tube
12 longitudinal press stamp
13 blade
14 stop plate
15 drive roller
16 side wall
17 intermediate storage
18 shelf
19 support bar
20 strap
20a deflecting drum
20b deflecting roller
F1-F10 vehicle
LS food piece
P portion
S slice
T part
V packaging element, tray
X transport direction, 1. horizontal direction
Y 2nd horizontal direction

1. A method of producing a portion in a precise position according to at least one predetermined portioning parameter from one or more parts, in particular slices, in the form of a foodstuff in or on a packaging element,
in particular from slices which have been separated from a regularly or also irregularly shaped food piece,
by
placing or dropping the one part or the several parts one after the other on a in transport direction single-part or multi-part feed conveyor unit,
the position and/or rotational position of the at least one part on the feed conveyor unit is detected,
the at least one part is dropped from the feed conveyor unit onto the packaging element, wherein previously
the packaging element has been positioned in a defined position on a vehicle, which is alone drive-less,
the drive-less vehicle is driven from below the driving surface and is positioned with respect to position and/or rotational position below the discharge end of the feed conveyor unit at a catching position in such a way that the part discharged by the discharging feed conveyor of the feed conveyor unit hits the packaging element in the desired nominal position.

2. The method according to claim 1,
wherein
in the case of a portion consisting of several parts
A) the portion or a partial portion consisting of several parts is formed on the feed conveyor unit by depositing several parts thereon, in particular successively
and/or
B) the portion or a partial portion consisting of several parts is formed on the packaging element by dropping one or more parts, in particular a partial portion, by means of the feed conveyor unit thereon, in particular successively.

3. The method according to claim 1,
wherein
the determination of the catching position for the vehicle is carried out taking into account catching parameters, in particular
the detected actual position and/or rotational position of the at least one part on the feed conveyor
and/or
the ejection speed of the at least one part by the discharging feed conveyor
and/or
the detected weight of the at least one part on the infeed conveyor unit
and/or
the detected actual position of the preceding one or more parts on the discharging feed conveyor and/or the packing element
and/or
the trend of the change of the determined actual position of the one or more parts on the discharging feed conveyor and/or the packaging element.

4. The method according to claim 3,
wherein the packaging element, in particular also the vehicle, is in motion when the part hits it,
wherein
speed and/or direction of the movement of the packaging element, in particular also of the vehicle, are determined at the catching position, taking into account the catching parameters.

5. The method according to claim 1,
wherein
at least one sorting parameter of the part is determined prior to dropping on the feed conveyor and is stored in association with the part, in particular during the stay on the feed conveyor, in particular
the weight of the part
and/or
the size of the part in its main plane and/or transversely thereto
and/or
the curvature of the part
and/or
the color of the part
and/or
the elasticity of the part
and/or
the temperature of the part.

6. The method according to claim 1,
wherein
for producing a portion from a plurality of parts
a first part of the portion is deposited on the packaging element of the vehicle
this vehicle) is parked apart,
when a next part suitable for the portion in the sense of at least one portioning parameter is available on the discharging feed conveyor of the feed conveyor unit, in particular of several parts, which drops onto the vehicle
this vehicle is moved to the catching position,
this next part is deposited on the packaging element of this vehicle,
the process is repeated until the desired portion is completed.

7. The method according to claim 1,
wherein
the suitability of the part for the portion and its portioning parameters is determined on the basis of one or more of the sorting parameters.

8. The method according to claim 1,
wherein
upstream of the discharging feed conveyor, parts or portions are intermediate stored separately from one another,
which, in particular, can be selectively transferred to the discharging feed conveyor,
the next suitable part for the portion is made available on the discharging feed conveyor from an intermediate storage, in particular a stationary intermediate storage.

9. The method according to claim 1,
wherein
the vehicle maintains the rotational position of the vehicle unchanged when its direction of travel is changed, which is done in particular only by 90° in each case.

10. The method according to claim 1,
wherein
the vehicle, at least when stationary, is driven in rotation about a vertical axis of the vehicle, in particular on the stationary point.

11. The method according to claim 1,
wherein
the vehicle is driven in rotation about a vertical axis of the vehicle during travel, in particular also during the change in its direction of travel and in particular as a function of the change in the direction of travel, and as a result cornering of the vehicle is effected with a change in its rotational position
and/or
the vehicle can be moved from a starting position in all directions of the usually two-dimensional driving surface.

12. A storage device for the positionally accurate production of a portion according to at least one predetermined portioning parameter from one or more, in particular shape-containing, parts in the form of, in particular, a foodstuff in or on a packaging element comprising:
an in the conveying direction single-part or multi-part feed conveyor unit which conveys the portion or a partial portion and includes an discharging feed conveyor,
a vehicle system with a plurality of vehicles which alone are without drive, which is embodied in such a way that the vehicles travel on a travel surface or hover above a travel surface and can be driven independently of one another by a drive arranged below the travel surface and can thus be precisely positioned with regard to position and/or rotational position at a catching position below the discharging feed conveyor
a control for controlling at least movable parts of the storage device.

13. The storage device according to claim 12,
wherein
each vehicle has a mounting device in order to be able to fasten to it on its upper side in a defined position, in particular in a form-fitting manner, a format plate which is matched to the packaging element to be arranged on its upper side, in particular is matched in a form-fitting manner,
in particular the mounting device is embodied such that the same format plate can be arranged on the vehicle in at least two different positions, in particular rotated relative to one another about the vertical axis.

14. The storage device according to claim 12,
wherein the driving surface is the closed and preferably closed and flat upper side of a driving plate made of easily cleanable material, in particular stainless steel.

15. The storage device according to claim 12,
wherein
the storage device comprises an additional intermediate storage for parts such as slices, in particular without a packaging element underneath the part,
in particular in the form of a vertical intermediate storage with a vertically controlled movable storage shelf with compartments open on both sides in conveying direction and arranged one above the other.
